(19) United States
(12) Patent Application Publication
(10) Pub. No.: US 2025/0173640 A1
(43) Pub. Date: May 29, 2025

(54) SYSTEM AND METHOD FOR MODIFYING DATA FORMATS FOR USE IN AN ALTERNATIVE DATA MANAGEMENT SYSTEM

(71) Applicant: BANK OF AMERICA CORPORATION, Chartotte, NC (US)

(72) Inventors: Tanya A. Wilson, Newark, DE (US); Malinda Kieffer, Chillicothe, MO (US); Ravinder Kaur Sodhi, Royse City, TX (US); Robert Ronald Rosseland, JR., Huntersville, NC (US); Donna Lee Phillips, Elkton, MD (US); Rahul Kumar Mishra, Skillman, NJ (US); Kiran Boosetty, Jacksonville, FL (US); Gerard P. Gay, Seattle, WA (US); Samuel M. Moiyallah, JR., Newark, DE (US); Susan J. Moss, Vestal, NY (US); Andrzej Grabski, Glen Rock, NJ (US)

(73) Assignee: BANK OF AMERICA CORPORATION, Charlotte, NC (US)

(21) Appl. No.: 18/520,238

(22) Filed: Nov. 27, 2023

(51) Int. Cl. G06Q 10/0631

(52) U.S. Cl. CPC G06Q 10/063112; G06Q 10/063114

(57) ABSTRACT

Systems, computer program products, and methods are described herein for the implementation of an alternative data management system. The method includes dividing a process into one or more tasks, including a first task, to be completed. The method also includes determining a first task availability status for the first task. The first task availability status indicates whether the first task can be started by a user. The first task availability is designated as waiting in an instance in which at least one prerequisite task exists for the first task. The method includes causing the first task availability status to be changed from waiting to ready in an instance in which at least a portion of the prerequisite task(s) is completed. The method further includes assigning the first task to a first user in an instance in which the first user finishes one of the one or more tasks.

### TECHNOLOGICAL FIELD

Example embodiments of the present disclosure relate generally to modifying data and, more particularly, to modifying data formats for use in an alternative data management system.

### BACKGROUND

Data formats are typically created for specific data management systems. As such, converting data to different data formats for a new data management system may be difficult. Applicant has identified a number of deficiencies and problems associated with such conversions. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for a system and method for modifying data formats for use in an alternative data management system. In an example embodiment, a system for determining and assigning tasks for one or more users in a virtual environment is provided. The system includes at least one non-transitory storage device containing instructions and at least one processing device coupled to the at least one non-transitory storage device. The at least one processing device, upon execution of the instructions, is configured to divide a process into one or more tasks to be completed. The one or more tasks include a first task. The at least one processing device, upon execution of the instructions, is also configured to determine a first task availability status for the first task. The first task availability status indicates whether the first task can be started by one of one or more users. The first task availability is designated as waiting in an instance in which at least one prerequisite task of the one or more tasks needs to be at least partially completed before the first task can be started. The at least one processing device, upon execution of the instructions, is further configured to, in an instance the determined first task availability for the first task is waiting, cause the first task availability status of the first task to be changed from waiting to ready in an instance in which at least a portion of each of the at least one prerequisite task is completed. The at least one processing device, upon execution of the instructions, is still further configured to assign the first task to a first user of the one or more users in an instance in which the first user finishes one of the one or more tasks.

In various embodiments, the at least one processing device, upon execution of the instructions, is also configured to generate a user efficiency rating for each of the one or more users with the user efficiency rating indicating at least one of a speed rating or an accuracy rating of the given user based on one or more previous tasks completed by the given user.

In various embodiments, the at least one processing device, upon execution of the instructions, is also configured to determine a task of the one or more tasks to be assigned to the first user based on the user efficiency rating of the first user. In various embodiments, the at least one processing device, upon execution of the instructions, is also configured to determine a task of the one or more tasks to be assigned to each of the one or more users based on the user efficiency rating for each of the one or more users.

In various embodiments, the at least one processing device, upon execution of the instructions, is also configured to determine a user availability for each of the one or more users with the user availability indicating one or more time periods in which each of the one or more users are available. In various embodiments, the at least one processing device, upon execution of the instructions, is also configured to update the user availability of at least one of the one or more users in an instance in which an availability change request is received.

In various embodiments, the at least one processing device, upon execution of the instructions, is also configured to train a machine learning model based on one or more tasks completed by the one or more users.

In various embodiments, the at least one processing device, upon execution of the instructions, is also configured to assign a task designated as ready of the one or more tasks to a first user of the one or more users in an instance in which the first user finishes one of the one or more tasks.

In another example embodiment, a computer program product for determining and assigning tasks for one or more users in a virtual environment, the computer program product includes at least one non-transitory computer-readable medium having computer-readable program code portions embodied therein. The computer-readable program code portions include one or more executable portions configured to divide a process into one or more tasks to be completed The one or more tasks include a first task. The computer-readable program code portions include one or more executable portions also configured to determine a first task availability status for the first task. The first task availability status indicates whether the first task can be started by one of one or more users. The first task availability is designated as waiting in an instance in which at least one prerequisite task of the one or more tasks needs to be at least partially completed before the first task can be started. The computer-readable program code portions include one or more executable portions further configured to, in an instance the determined first task availability for the first task is waiting, cause the first task availability status of the first task to be changed from waiting to ready in an instance in which at least a portion of each of the at least one prerequisite task is completed. The computer-readable program code portions include one or more executable portions still further configured to assign the first task to a first user of the one or more users in an instance in which the first user finishes one of the one or more tasks.

In various embodiments, the computer-readable program code portions include one or more executable portions configured to generate a user efficiency rating for each of the one or more users with the user efficiency rating indicating at least one of a speed rating or an accuracy rating of the given user based on one or more previous tasks completed by the given user.

In various embodiments, the computer-readable program code portions include one or more executable portions configured to determine a task of the one or more tasks to be assigned to the first user based on the user efficiency rating of the first user.

In various embodiments, the computer-readable program code portions include one or more executable portions configured to determine a task of the one or more tasks to be assigned to each of the one or more users based on the user efficiency rating for each of the one or more users.

In various embodiments, the computer-readable program code portions include one or more executable portions configured to determine a user availability for each of the one or more users with the user availability indicating one or more time periods in which each of the one or more users are available.

In various embodiments, the computer-readable program code portions include one or more executable portions configured to update the user availability of at least one of the one or more users in an instance in which an availability change request is received. In various embodiments, the computer-readable program code portions include one or more executable portions configured to train a machine learning model based on one or more tasks completed by the one or more users.

In various embodiments, the computer-readable program code portions include one or more executable portions configured to assign a task designated as ready of the one or more tasks to a first user of the one or more users in an instance in which the first user finishes one of the one or more tasks.

In still another example embodiment, a method for determining and assigning tasks for one or more users in a virtual environment is provided. The method includes dividing a process into one or more tasks to be completed. The one or more tasks include a first task. The method also includes determining a first task availability status for the first task. The first task availability status indicates whether the first task can be started by one of one or more users. The first task availability is designated as waiting in an instance in which at least one prerequisite task of the one or more tasks needs to be at least partially completed before the first task can be started. The method further includes, in an instance the determined first task availability for the first task is waiting, causing the first task availability status of the first task to be changed from waiting to ready in an instance in which at least a portion of each of the at least one prerequisite task is completed. The method still further includes assigning the first task to a first user of the one or more users in an instance in which the first user finishes one of the one or more tasks.

In various embodiments, the method includes determining a user efficiency rating indicating at least one of a speed rating or an accuracy rating of the given user based on one or more previous tasks completed by the given user. The method includes the determination of a task of the one or more tasks to be assigned to each of the one or more users is based on the user efficiency rating for each of the one or more users.

The method also includes training a machine learning model based on one or more tasks completed by the one or more users.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an example distributed computing environment for modifying data formats for use in an alternative data management system, in accordance with various embodiments of the present disclosure;

FIG. 2 illustrates an example machine learning (ML) subsystem architecture 200 used in accordance with various embodiments of the present disclosure; and

FIG. 3 illustrates a process flow for modifying data formats for use in an alternative data management system, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data. An “entity” can encompass a wide range of organizations, such as institutions, groups, associations, financial institutions, establishments, companies, unions, authorities, and similar entities. The common factor among these entities is their utilization of information technology resources for processing substantial amounts of data. As such, an “entity” in this context denotes any organization or institution that employs information technology resources capable of processing large volumes of data, which can pertain to different aspects of the entity's operations.

As described herein, a “user” may be an individual associated with an entity. As such, in some embodiments, the user may be an individual having past relationships, current relationships or potential future relationships with an entity (e.g., a customer at a financial institution). In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, an “artificial intelligence” (AI) system is a computing framework designed to perform tasks that normally require human intelligence, such as understanding natural language, recognizing patterns, problem-solving, and making decisions. It is understood that these systems operate by mimicking the neural networks of humans in a simplified form. In some embodiments, they may consist of interconnected layers of nodes, often referred to as artificial neurons, that process information using dynamic state responses to external inputs. They are trained by feeding them large volumes of data and adjusting the connections between the nodes using complex mathematical algorithms based on the principles of statistics and calculus, allowing them to learn from this data. In some embodiments, an AI system may be stored and executed in various ways depending on the requirements of the specific implementation. It is understood that AI systems can be hosted on local machines, in data centers, or in the cloud. It is further understood that cloud-based AI systems are becoming increasingly common due to their scalability, cost-effectiveness, and the ability to handle vast amounts of data. AI systems may be employed for identifying data patterns and vulnerability vectors due to their ability to analyze large and complex datasets rapidly and accurately.

As used herein “machine learning” (ML), a subset of AI, may be utilized in some embodiments. ML algorithms learn from the data they process, enabling them to discover hidden insights and patterns that may not be apparent to human analysts. For instance, in cybersecurity, AI systems can analyze network traffic to identify patterns consistent with cyber threats or vulnerabilities, providing an effective tool for proactively safeguarding systems and data. It is understood that there are several types of ML algorithms, each suited to different types of tasks. These include supervised learning where the algorithm learns from labeled training data, and then applies what it has learned to new data. In further embodiments, unsupervised learning may employ unlabeled data and learn by identifying patterns and structures within it. Additionally, in some embodiments, reinforcement learning may involve an algorithm that learns by interacting with its environment and receives rewards or demerits based on its actions. Furthermore, semi-supervised learning may include a blend of supervised and unsupervised learning wherein various embodiments of the present disclosure employ the use of an algorithm which learns from a small amount of labeled data supplemented by a large amount of unlabeled data. Particularly regarding cybersecurity, ML may be used to identify patterns consistent with cyber vulnerabilities. The ML algorithm of various embodiments may analyze network traffic data, system logs, user behavior, or the like, and learn what “normal” activity looks like on an entity network infrastructure. Once the model has been trained on this data, it can then monitor network activity and identify anomalies or deviations from the normal pattern. These anomalies could potentially be cyber vulnerabilities, such as an intrusion, malicious activity, or use of a software vulnerability. This proactive approach to cybersecurity allows vulnerabilities to be detected and mitigated early, reducing the potential damage they may cause. In some embodiments, ML may provide valuable insights and automated decision-making capabilities across multiple entity communication channels.

Currently, software developers use a linear structure for project management that requires completion of one task before beginning a next task. The linear structured format for project management is restrictive and does not account for the differing rates of task completion among developers working on the same processes. Developers seek a data management system that allows users to move between tasks with flexibility and which involves dividing processes into tasks that become available upon at least partial completion of each prerequisite task. The organizational structure disclosed herein creates a more flexible and efficient data management system.

The present disclosure describes an alternate system, method, and/or computer product for task assignment in a data management system. The disclosed system divides a process into tasks and allows users to move between tasks depending on the availability of the task. Tasks become available when one prerequisite task of one or more prerequisite tasks is at least partially completed. As such, all available tasks that have no outstanding prerequisite tasks may be assignable to users on the network. A user may select or be assigned an available task in an instance in which the user has completed a previous task. The system may also be configured to train a machine learning model, based on data generated from tasks completed by the one or more users, to divide a process into tasks, manage task availability, assign tasks to the one or more users, and/or other aspects of the disclosure.

Traditional data management systems restrict the way users move between tasks creating an inefficient working environment. Traditional systems restrict users from moving to a next task until the current process is completed. As a result, users of varying efficiency rates are blocked from moving to a next task before completion of the current process. The traditional system stymies workflow by restricting more efficient users from beginning work on the next process.

The present disclosure circumvents the problem presented by traditional data management systems by introducing flexibility in the determination and assignment of tasks to users. Traditional data management systems restrict workflow by requiring total completion of a task before moving to a next task. An alternative data management system of the present disclosure introduces flexibility by first dividing a process into tasks. This system allows users to move between available tasks on the condition that each of the one or more tasks that comprise a prerequisite task be at least partially completed. Workflow is unrestricted in this sense because a user that has finished one of the one or more prerequisite tasks may move onto a next available task. The user is then assigned to the next task and may begin work on the task contemporaneously with users which continue to work on one or more prerequisite tasks. This system increases workflow efficiency by allowing more efficient users to begin work on the next available task which enables faster progression on the project as a whole.

Accordingly, the present disclosure provides for a process to be is divided into tasks. The system may also be configured to handle processes with multiple sublevels, wherein each sublevel of the one or more sublevels is divided into tasks in accordance with the present disclosure. A first task is designated as available on the condition that at least a portion of the one or more prerequisite tasks has been completed. The one of one or more users is designated as a first user on the condition that the user has completed at least one of the one or more prerequisite tasks. The first user may also be determined on the basis of user efficiency rankings. The first user is then assigned to the first task and is enabled to begin work on the first task contemporaneously with users who continue with work on the one or more prerequisite tasks. The system may also be used to train a machine learning model based on past completion of tasks by users.

What is more, the present disclosure provides a technical solution to a technical problem. As described herein, the technical problem includes restricted and inefficient data management systems wherein users are prevented from beginning work on the next process before the current process is completed. Additionally, converting from one data management system to another is difficult due to data formatting issues, creating processing issues and using time and resources. The technical solution presented herein allows for data used in a first data management system that uses linear structure processing to be converted in order to be used in a data management system that is more efficient for users.

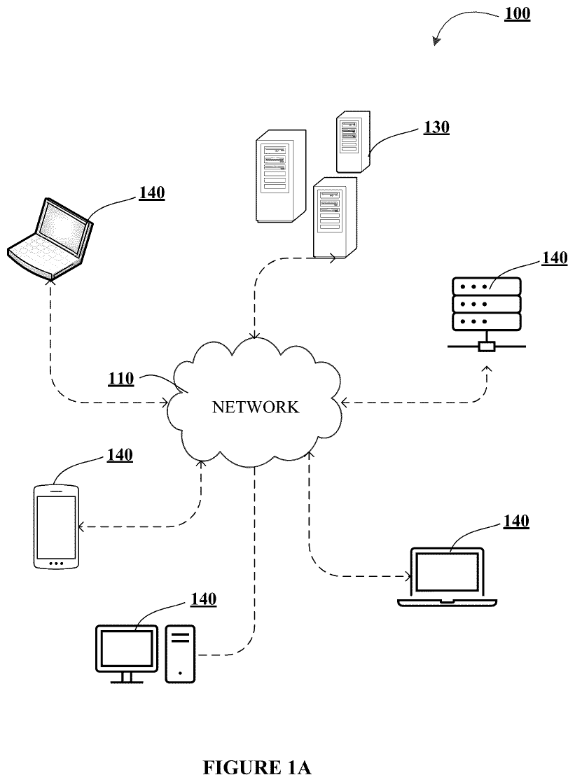

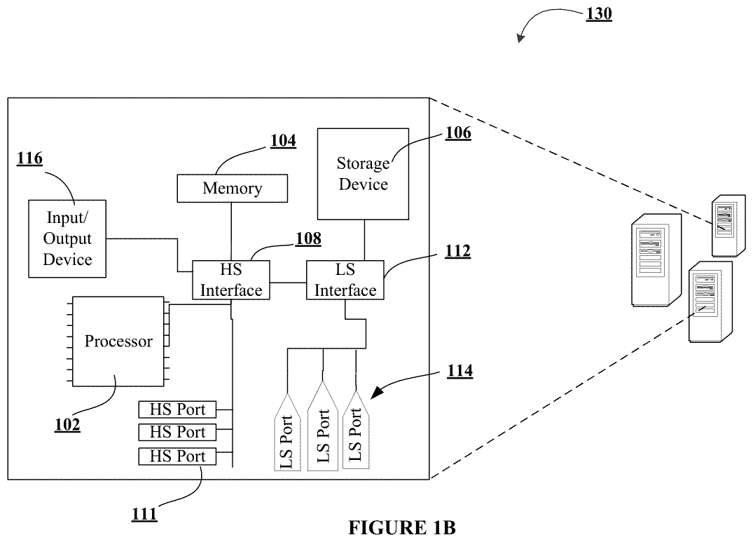

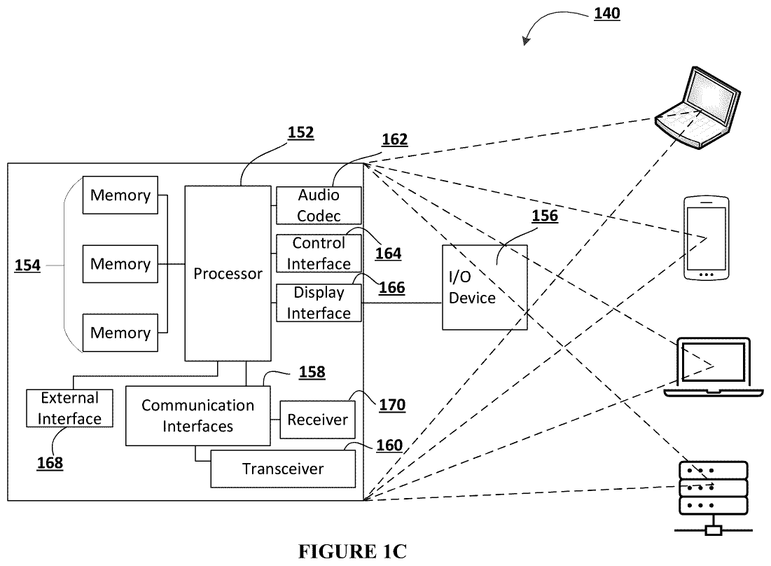

FIGS. 1A-1C illustrate technical components of an example distributed computing environment for modifying data formats for use in an alternative data management system, in accordance with an embodiment of the disclosure. As shown in FIG. 1A, the distributed computing environment 100 contemplated herein may include a system 130 (e.g., a network monitoring device), an end-point device(s) 140, and a network 110 over which the system 130 and end-point device(s) 140 communicate therebetween. In various embodiments, the system 130 may be embodied by one or more of the end-point devices 140. As such, any end-point device 140 may operate as the system 130.

FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to the shared communication within the network, the distributed network often also supports distributed processing. The network 110 may be a form of digital communication network such as a telecommunication network, a local area network (“LAN”), a wide area network (“WAN”), a global area network (“GAN”), the Internet, a satellite network, a cellular network, and/or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an example component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 (shown as “HS Interface”) connecting to the memory 104, and a low-speed interface 112 (shown as “LS Interface”) connecting to low-speed expansion port 114 (shown as “LS Port”) and storage device 106. Each of the components 102, 104, 106, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-readable or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an example component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

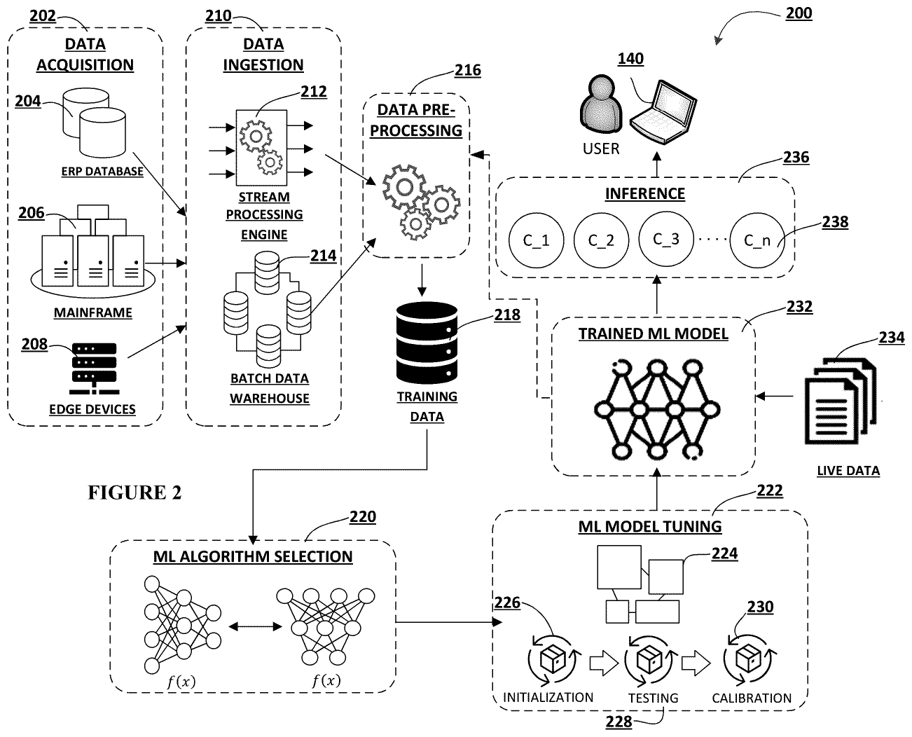

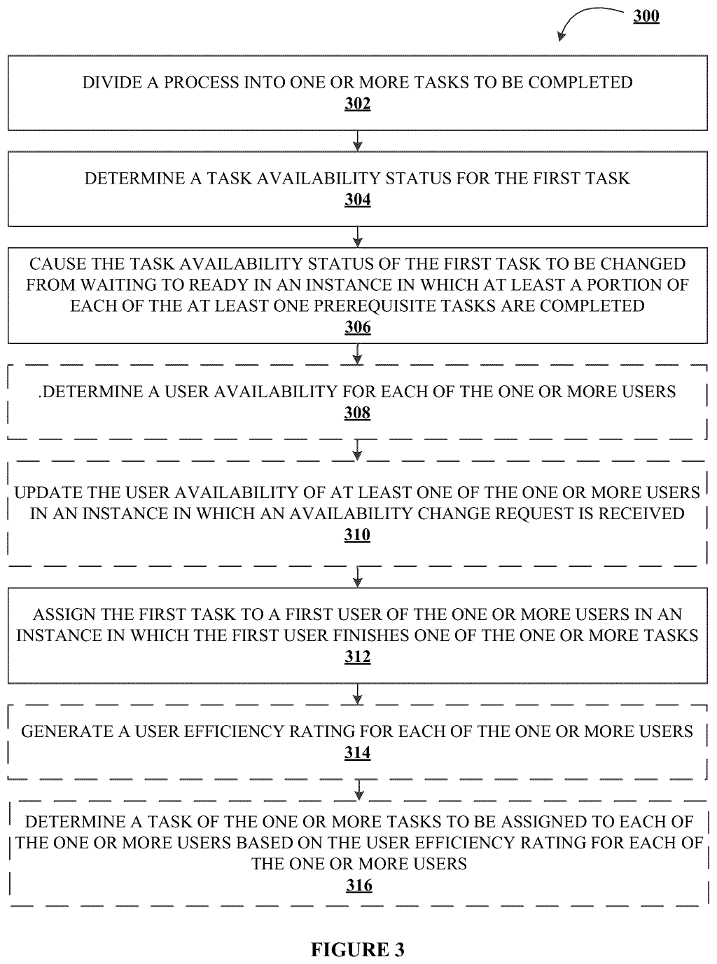

FIG. 2 illustrates an example machine learning (ML) architecture 200, in accordance with an embodiment of the present disclosure. The ML subsystem architecture may be part of the components of the environment 100 (e.g., end-point device(s) 140). The ML subsystem architecture is used to modify data formats for use in an alternative data management system, as discussed below in reference to FIG. 3. For example, the ML subsystem architecture may be used to perform any one of dividing processes into tasks, determining task availability, assigning tasks of the one or more tasks to the one or more users. Namely, the ML subsystem architecture may be used to train the system to identify available tasks and to determine assignment of the available tasks based on completion of at least one of the one or more prerequisite tasks by a given user.

The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 210, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2. . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is to be used as an example and that other embodiments may vary. As another example, in some embodiments, the machine learning subsystem 200 may include more, fewer, or different components.

FIG. 3 illustrates a process flow for modifying data formats for use in an alternative data management system, in accordance with various embodiments of the present disclosure. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein. Additionally, ML/AI may also be used, such as the ML/AI discussed in reference to FIG. 2.

In various embodiments, one or more of the end-point devices 140 associated with the network may be capable of executing one or more features of the process flow discussed herein. As such, each of the one or more of the end-point devices 140 associated with the network may include hardware to carry out the operations herein. Additionally, as discussed herein, various software programs and/or applications may be installed on a given end-point device to conduct the operations discussed herein.

While the disclosure refers to a first task, various other tasks may be determined, assigned, and otherwise processed as discussed herein. For example, the system may carry out the operations herein on any tasks of the one or more tasks. Additionally, the first user may refer to any user of the one or more users, such that any user may be assigned tasks, update user availability, and/or be associated with any of the other operations discussed herein related to a first user.

Referring now to Block 302 of FIG. 3, the system includes dividing a process into one or more tasks. In various embodiments, a process may include a series of one or more tasks which together accomplish one or more of the planned outcomes of the process. For example, a process may be any individual workflow that is being completed by one or more users and the task are the individual components to be completed in order to complete the workflow. As such, the process is greater in scope than the individual tasks (e.g., a process may include a first task, a second task, a third task, etc.)

As an example, the process may be defined as deploying software which is greater in scope than the individual tasks such as developing wireframes, developing code based on the wireframes, etc. When each and every one of the one or more tasks is completed, the planned one or more outcomes of the process are accomplished. In some embodiments, a process may be comprised of one or more sublevels wherein each task is itself comprised of one or more tasks. (e.g., first task comprised of first subtask, second subtask, third subtask, etc.)

A task is a component of a process which is smaller in scope than the process. The one or more tasks are actionable steps which accomplish one or more planned outcomes of the process when each and every of the one or more tasks are completed. As an example, tasks may include any one of developing wireframes, developing code based on the wireframes, testing the code, etc. In some embodiments, tasks may be defined for processes with one or more levels and/or sublevels. In a data management structure of this kind, a process is first divided into one or more tasks of a first sublevel, and each of those one or more tasks of the first sublevel are further divided into one or more tasks at a second sublevel, wherein the process is broader in scope than the one or more tasks of the first sublevel and which the one or more tasks of the first sublevel are broader in scope than tasks of the second sublevel (e.g., first task of first sublevel is comprised of first task of second sublevel, second task of second sublevel, third task of second sublevel, etc.)

A process is divided into individual tasks in accordance with the present disclosure. The process is divided into one or more tasks of which each and every task is smaller in scope than the process itself. The process is divided into one or more tasks on the basis of the specific requirements and/or planned outcomes of the process. The process is divided into one or more tasks which are actionable steps that may accomplish the one or more planned outcomes of the process when completed. The process may be divided into one or more tasks wherein each of the one or more tasks may be of any defined proportion of the process, wherein each division may be either equal or unequal in scope as measured against the scope of the other one or more tasks. In some embodiments, the process may be divided into multiple sublevels, wherein the process is first divided into one or more tasks at a first sublevel, and each of those one or more tasks of the first sublevel are further divided into one or more tasks of the second sublevel. In some embodiments, machine learning may be used to carry out the division of the process into one or more levels and/or sublevels, and the data management system may be used to train the machine learning model based on previous data.

Referring to Block 304 of FIG. 3, the method includes determining a task availability status for the first task. A task availability status indicates whether the given task may be assigned and/or selected for execution. In various instances, a task may use information from other tasks in order for the given task to be executed. For example, in an instance in which a first task is writing code for a software update and a second task is testing the code from the first task, the second task may need the code from the first task before any testing may be conducted.

In various embodiments, a task availability status of a task may be designated as either ready or waiting, with a ready status indicating users may engage with the task. The task status of the one or more tasks may be designated as ready min an instance in which each of the one or more prerequisite tasks are at least partially completed. The amount of the prerequisite task(s) that need to be completed may depend on the tasks. For example, in an instance in which a prerequisite task is producing code, testing of the code may begin once the code has been partially written such that testing may occur. The system may determine the amount of a prerequisite task that must be completed based on the type of task and/or previous processes (e.g., using ML/AI model(s) as discussed herein).

In the example that the task availability status of a task may be designated as either ready or waiting, a task may be designated as waiting in an instance in which at least one of the prerequisite task(s) has not at least partially completed. For example, a first task that has prerequisite tasks of a second task and a third task may be designated as waiting in an instance in which the second task and/or the third task is not started. Once each of the prerequisite task(s) adequately completed, the task availability status for the given task is designated as ready (e.g., the task availability status is changed from waiting to ready). Task availability status describes whether the task of one or more tasks is ready for the one or more users to engage with the task. While the task availability status is described in terms of binary (e.g., ready or waiting), the task availability status may also include additional status levels. For example, the number of prerequisite tasks may affect the status level (e.g., the task availability status may change as the prerequisite tasks are completed and fewer prerequisite tasks remain outstanding). Additionally, ready and waiting are merely descriptive labels and need not have the exact same label (e.g., the labels could be 0 and 1, in which 0 indicates that the task is ready and in 1 indicates the task is waiting or otherwise not ready).

In various embodiments, the first task availability status indicates whether the first task can be started by one of one or more users. As such, one or more of the task(s) may have an individual task availability status (e.g., the first task may have a first task availability status, a second task may have a second task availability status, a third task may have a third task availability status, etc.). In various embodiments, the task availability status for a task may be determined based on one or more prerequisite tasks for the given task. A prerequisite task is any task that must be at least partially completed before the given task may be assigned and/or started.

The prerequisite task is determined on the basis of the specific requirements and planned outcomes of the process. In some embodiments, the one or more tasks have a defined order of completion on the basis of a relationship between at least two tasks of the one or more tasks. The relationship may be defined as one task having a dependence on another task. When one task depends on another, the completion of the next task may only be possible upon at least partial completion of the other task which precedes the task based on a defined order. In some embodiments, the system may be configured to handle processes that include one or more levels and/or sublevels. In such a system, each and every task of a second sublevel must be at least partially completed in order to consider the prerequisite task at a first sublevel satisfactory of the condition. The first task of the first sublevel may now be designated as ready (e.g., the prerequisite task of the one or more tasks of the first sublevel may only satisfy the condition upon at least partial completion of a first task of the second sublevel, a second task of the second sublevel, a third task of the second sublevel, etc.) In this instance, the first task of the first sublevel may be designated as ready.

In various embodiments, the first task availability is designated as waiting in an instance in which at least one prerequisite task of the one or more tasks needs to be at least partially completed before the first task can be started. A waiting task availability status indicates that users may not engage with the task of the one or more tasks. In some embodiments, users may not start work on a task with a waiting task availability status. In some embodiments, one or more users must at least partially complete the coding for the prerequisite task in order to move to the first task and thereby change the task availability of the first task from waiting to ready. In this system, tasks may be necessarily dependent on each other, on the basis of the specific requirements and planned outcomes of the process and require completion of the prerequisite code to provide one or more users with the foundation to start work on the first task.

A ready task availability status indicates that a first task may be engaged by one or more users. A first task may only be designated as ready when a condition is satisfied wherein the condition refers to the at least partial completion of the prerequisite task. In some embodiments, the first task is related to the prerequisite task. This relationship may be described as the one task of at least two tasks depending on the other task. In this embodiment, the user of the one or more users cannot start work on the first task due to a deficiency of information. In some embodiments, the information may be defined as code that must be written in order to continue work on the preceding code. For example, the first task may be defined as developing code based on one or more wireframes with the prerequisite task defined as developing the one or more wireframes.

Referring to Block 306 of FIG. 3, the system includes causing the task availability status of the first task to be changed from waiting to ready in an instance in which at least a portion of each of the at least one prerequisite tasks are completed.

A task status may only be changed from waiting to ready in an instance in which each of the one or more prerequisite tasks is at least partially completed. In the instance in which each of the one or more prerequisite tasks is at least partially completed, the task availability status of the first task is changed from waiting to ready. Until each of the one or more prerequisite tasks is at least partially completed, the task availability status of the first task remains designated as waiting. In various embodiments, the system may assign and/or users may select task(s) that are designated as ready. As such, once the task availability status of the first task is designated as ready, users may be assigned and/or start work on the first task (e.g., start coding as defined for that task).

Referring to optional Block 308 of FIG. 3, the system includes determining a user availability for each of the one or more users. In various embodiments, the system may assign tasks to user based on the user availability for each user. User availability is determined on the basis of the user's ability to engage with one or more tasks. In some embodiments, the user's availability is determined on the basis of the user's work schedule, unexpected disruptions to the user's work schedule, and/or another event that impacts the user's ability to engage with one or more tasks. In some embodiments, user availability may also be determined by the efficiency of the user, as discussed below in reference to Block 316.

A user may be unavailable for a task in the event that the user remains engaging with one or more tasks and is not available for engagement with one or more other tasks. The time spent engaging with a task may impact the user's availability for other tasks (e.g., user which spends less time on a task is available to start work on one or more other tasks, as measured against the one or more users which work more slowly and may not complete tasks as efficiently). In instances in which the user has the ability to engage with one or more tasks, as determined by the user's schedule, the user is designated as available.

In some embodiments, the user may submit a request to change the user's availability designation. in an instance in which the request is received, the user's availability may be updated, as discussed in reference to Block 310. In an instance in which the user's availability request is not received and/or processed, the user availability status may remain the same (e.g., based on typical work schedule). In some embodiments, a machine learning algorithm is used to determine a user availability. Namely, the ML/AI model(s) may be used to determine instance in which a user is likely unavailable (e.g., a user may not have logged into the given user's computer for an extended amount of time).

Referring to optional Block 310 of FIG. 3, the method includes updating the user availability of at least one of the one or more users in an instance in which an availability change request is received. User availability reflects the periods of time in which a user is available to engage with the one or more tasks assigned to the user. When one or more users submit availability change requests, the request is processed and results in a change to the availability status of the user.

The system is configured to store the availability of each and every of the one or more users. The system is also configured to update the user availability status of each user and store changes in the system. In the event that the user availability status of the one or more users is changed, the system is configured to compensate for the user's absence and in order to maintain engagement levels with the one or more tasks. In some embodiments, changes in user availability status of a user may cause any tasks assigned to the user to be reassigned to another users that are available.

In some embodiments, the tasks are reassigned in accordance with one or more factors, including user efficiency and/or length of the absence of the one or more users. In some embodiments, one or more available users may request assignment of the task, formerly assigned to the one or more unavailable users, to the one or more users. In some embodiments, a machine learning algorithm may be used to determine the reassignment of tasks due to the unavailability of one or more users on the basis of the requirements and planned outcomes of the process as well other attributes of the one or more available users.

Referring to Block 312 of FIG. 3, the method includes assigning the first task to a first user of the one or more users in an instance in which the first user finishes one of the one or more tasks. An initial assignment of a task to the user(s) may be based on the initiation of one of the user(s) to select the task. Additionally or alternatively, the system may automatically assign task(s) to the individual user(s) based on one or more rules shared among the one or more users. The one or more tasks may be assigned to the one or more users in accordance with one or more factors, such as user availability, task type, user efficiency rating, and/or the like. In some embodiments, assignment is performed on the basis of user efficiency (e.g., more efficient users are assigned tasks which are larger and/or more difficult tasks). Tasks may also be assigned on the basis of user availability. A machine learning algorithm may be implemented to assign tasks to the one or more users.

In various embodiments, user(s) are assigned a task and then each user is assigned a next task, upon completion of the previously assigned task by the given user. The assignment of the task may be determined by one or more factors, such as user efficiency rating, user availability, initiation by the one or more users, and/or the like. In various embodiments, a user may be assigned multiple tasks at once. In such an instance, the tasks assigned to a user may be monitored to determine whether any of the tasks should be reassigned. For example, the tasks may be evenly distributed across the users, but as the tasks are being executed, some users may be slower than others in completing tasks and a task that was previously assigned to a first user may be reassigned to a second user.

Referring to optional Block 314 of FIG. 3, the method includes generating a user efficiency rating for each of the one or more users. The user efficiency rating indicates the performance level of a given user at one or more tasks within a proscribed time period. The performance level of the user may be based on the user's accuracy and/or speed (e.g., fewer mistakes made while performing a task in less time). A user that are faster and more accurate receive a higher user efficiency than a user that is slower and less accurate.

In various embodiments, the user efficiency ratings may be relied on as a factor in task assignment. More efficient users may be assigned time intensive tasks and/or tasks of greater difficulty. User efficiency ratings may be based on the specific requirements and/or planned outcomes of the process. In some embodiments, user efficiency ratings may be generated for one or more groups of tasks. As an example, user efficiency ratings by generated for the one or more users working on a group of tasks each of which involve a particular coding language. In this embodiment, users may be granted one or more user efficiency ratings which are generated from one or more groups of one or more tasks. For example, a first user may be more proficient in coding a first language than coding in a second language, and as such would have a higher user efficiency rating for task that include coding in the first language. In accordance with this embodiment, a user may have a low user efficiency for one or more group of tasks and a high user efficiency for one or more other groups of tasks. As such, the assignment of tasks may consider overall user efficiency rating and/or user efficiency rating based on the task type.

Referring to optional Block 316 of FIG. 3, the method includes determining a task of the one or more tasks to be assigned to each of the one or more users based on the user efficiency rating for each of the one or more users. The assignment of one or more tasks to one or more users may depend on the user efficiency rating generated for each and every one of the one or more users. User efficiency ratings may be defined as ratings depending on the speed at which a user completes a task while also maintaining a high level of accuracy of the one or more tasks. Higher rated users may be assigned more difficult or more time intensive tasks while less highly rated users may be assigned tasks determined to be appropriate for these one or more users. In some embodiments, multiple user efficiency ratings are generated for multiple groupings of one or more tasks. Tasks may be grouped based on common features of each of the one or more tasks. As an example, tasks may be grouped by the type of coding language used for the one or more tasks.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining and assigning tasks for one or more users in a virtual environment, the system comprising:
at least one non-transitory storage device containing instructions; and
at least one processing device coupled to the at least one non-transitory storage device, wherein the at least one processing device, upon execution of the instructions, is configured to:
divide a process into one or more tasks to be completed, wherein the one or more tasks comprise a first task;
determine a first task availability status for the first task, wherein the first task availability status indicates whether the first task can be started by one of one or more users, wherein the first task availability is designated as waiting in an instance in which at least one prerequisite task of the one or more tasks needs to be at least partially completed before the first task can be started;
in an instance the determined first task availability for the first task is waiting, cause the first task availability status of the first task to be changed from waiting to ready in an instance in which at least a portion of each of the at least one prerequisite task is completed; and
assign the first task to a first user of the one or more users in an instance in which the first user finishes one of the one or more tasks.

2. The system of claim 1, wherein the at least one processing device, upon execution of the instructions, is configured to generate a user efficiency rating for each of the one or more users, wherein the user efficiency rating indicates at least one of a speed rating or an accuracy rating of the given user based on one or more previous tasks completed by the given user.

3. The system of claim 2, wherein the at least one processing device, upon execution of the instructions, is configured to determine a task of the one or more tasks to be assigned to the first user based on the user efficiency rating of the first user.

4. The system of claim 2, wherein the at least one processing device, upon execution of the instructions, is configured to determine a task of the one or more tasks to be assigned to each of the one or more users based on the user efficiency rating for each of the one or more users.

5. The system of claim 1, wherein the at least one processing device, upon execution of the instructions, is configured to determine a user availability for each of the one or more users, wherein the user availability indicates one or more time periods in which each of the one or more users are available.

6. The system of claim 5, wherein the at least one processing device, upon execution of the instructions, is configured to update the user availability of at least one of the one or more users in an instance in which an availability change request is received.

7. The system of claim 1, wherein the at least one processing device, upon execution of the instructions, is configured to train a machine learning model based on one or more tasks completed by the one or more users.

8. The system of claim 1, wherein the at least one processing device, upon execution of the instructions, is configured to assign a task designated as ready of the one or more tasks to a first user of the one or more users in an instance in which the first user finishes one of the one or more tasks.

9. A computer program product for determining and assigning tasks for one or more users in a virtual environment, the computer program product comprising at least one non-transitory computer-readable medium having computer-readable program code portions embodied therein, the computer-readable program code portions comprising one or more executable portions configured to:
divide a process into one or more tasks to be completed, wherein the one or more tasks comprise a first task;
determine a first task availability status for the first task, wherein the first task availability status indicates whether the first task can be started by one of one or more users, wherein the first task availability is designated as waiting in an instance in which at least one prerequisite task of the one or more tasks needs to be at least partially completed before the first task can be started;
in an instance the determined first task availability for the first task is waiting, cause the first task availability status of the first task to be changed from waiting to ready in an instance in which at least a portion of each of the at least one prerequisite task is completed; and
assign the first task to a first user of the one or more users in an instance in which the first user finishes one of the one or more tasks.

10. The computer program product of claim 9, wherein the computer-readable program code portions comprising one or more executable portions are also configured to generate a user efficiency rating for each of the one or more users, wherein the user efficiency rating indicates at least one of a speed rating or an accuracy rating of the given user based on one or more previous tasks completed by the given user.

11. The computer program product of claim 10, wherein the computer-readable program code portions comprising one or more executable portions are also configured to determine a task of the one or more tasks to be assigned to the first user based on the user efficiency rating of the first user.

12. The computer program product of claim 10, wherein the computer-readable program code portions comprising one or more executable portions are also configured to determine a task of the one or more tasks to be assigned to each of the one or more users based on the user efficiency rating for each of the one or more users.

13. The computer program product of claim 9, wherein the computer-readable program code portions comprising one or more executable portions are also configured to determine a user availability for each of the one or more users, wherein the user availability indicates one or more time periods in which each of the one or more users are available.

14. The computer program product of claim 13, wherein the computer-readable program code portions comprising one or more executable portions are also configured to update the user availability of at least one of the one or more users in an instance in which an availability change request is received.

15. The computer program product of claim 9, wherein the computer-readable program code portions comprising one or more executable portions are also configured to train a machine learning model based on one or more tasks completed by the one or more users.

16. The computer program product of claim 9, wherein the computer-readable program code portions comprising one or more executable portions are also configured to assign a task designated as ready of the one or more tasks to a first user of the one or more users in an instance in which the first user finishes one of the one or more tasks.

17. A method for determining and assigning tasks for one or more users in a virtual environment, the method comprising:
dividing a process into one or more tasks to be completed, wherein the one or more task comprise a first task;
determining a first task availability status for the first task, wherein the first task availability status indicates whether the first task can be started by one of one or more users, wherein the first task availability is designated as waiting in an instance in which at least one prerequisite task of the one or more tasks needs to be at least partially completed before the first task can be started;
in an instance the determined first task availability for the first task is waiting, causing the first task availability status of the first task to be changed from waiting to ready in an instance in which at least a portion of each of the at least one prerequisite task is completed; and
assigning the first task to a first user of the one or more users in an instance in which the first user finishes one of the one or more tasks.

18. The method of claim 17, further comprising determining a user efficiency rating indicating at least one of a speed rating or an accuracy rating of the given user based on one or more previous tasks completed by the given user.

19. The method of claim 18, wherein the determination of a task of the one or more tasks to be assigned to each of the one or more users is based on the user efficiency rating for each of the one or more users.

20. The method of claim 17, wherein a machine learning model is trained based on one or more tasks completed by the one or more users.
